(19) United States
(12) Patent Application Publication
(10) Pub. No.: US 2010/0130236 A1
(43) Pub. Date: May 27, 2010

(54) LOCATION ASSISTED WORD COMPLETION

(75) Inventors: Sunil Sivadas, Tampere (FI); Mathias Johan Philip Creutz, Helsinki (FI)

Correspondence Address: DITTHAVONG MORI & STEINER, P.C., 918 Prince Street, Alexandria, VA, 22314, US

(73) Assignee: NOKIA CORPORATION, Espoo (FI)

(21) Appl. No.: 12/323,600

(22) Filed: Nov. 26, 2008

(51) Int. Cl. H04W 4/02

(52) U.S. Cl. 455/456.6

(57) ABSTRACT

Embodiments include systems and methods for providing location and object specific word completion assistance. Sensors may detect information regarding a landmark, location or object, and an embodiment may identify such landmarks, locations and objects and provide word lists to assist a user in entering text. Identification of such places and objects may include receiving information from one or more sensors; such information includes location and orientation information, near field communications information, and images. Images may be analyzed to determine objects and locations in the images.

### FIELD OF THE INVENTION

Embodiments of the invention relate generally to data input, and more particularly to text and word completion based on location factors.

### BACKGROUND OF THE INVENTION

Mobile phones have been widely used for reading and composing text messages including longer text messages with the emergence of email and web enabled phones. Such text entry on mobile phones is often limited to entry on the standard numeric keypad, requiring multiple key presses to enter one alphanumeric letter. This process is tedious and slow.

Other types of devices such as PDAs (personal digital assistants), wireless devices, and mobile terminals may have other text entry devices, such as a partial or complete alphanumeric keypad, pen and stylus character recognition, and some type of limited speech entry, such as entry of individually recognized letters. Although these text entry devices may have some improvement over a numeric keypad, text entry is still tedious and slow.

One method to help improve text entry, no matter how it is performed, is through the use of word completion. This technology works to predict a word or phrase that a user is entering, and either automatically completes the word or phrase, or provides the user with an easy option to accept the completion. For example a user will type “A A R D” and the word completion process will then provide the remaining letters to complete the word Aardvark. Different types of word completion features are available for determining what words might match what a user has already entered, and actions to take when several works may match what the user has entered so far.

Such word completion methods and systems typically do a dynamic comparison as the user enters letters against a list of potential matching words. Often this list of matching words is simply a database of common words with no context to what a user is entering.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Embodiments of the present invention include a method of receiving input comprising one or more characters; determining if sensor data regarding a location is available; if sensor data regarding a location is available, determining a geographical location, and processing the sensor data to identify at least one object positioned proximate the determined geographical location; obtaining at least one location specific word based on the identified at least one object; and determining if the at least one location specific word would match the received one or more input characters into a word, and if so, presenting the at least one matched word as a potential completion. Processing the sensor data to identify at least one object positioned proximate the determined a geographical location may include transmitting to a wireless network information regarding the determined geographical location; receiving from the wireless network information regarding objects proximate to the determined geographical location; and utilizing the received information regarding objects proximate to the determined geographical location to identify the at least one object from the sensor data. Obtaining at least one location specific word based on the identified at least one object may include transmitting to a wireless network information regarding the identified at least one object; and receiving from the wireless network the least one location specific word.

In one or more embodiments, sensor data may include a camera image. Similarly, the determined geographical location may include the geographical location where the camera image was created. Identifying an object in the camera image may include determining a geographical orientation for the camera image; and utilizing the determined geographical location and the determined geographical orientation to identify at least one object positioned proximate the determined geographical location. Embodiments may also include calculating a distance value to an object determined to be in the camera image; and utilizing the distance value along with the determined geographical location and the determined geographical orientation to identify at least one object positioned proximate the determined geographical location.

In an embodiment, the process of presenting the at least one matched word as a potential completion includes presenting a list of possibly matching words, wherein the at least one matched word is prioritized in the presentation list. Embodiments may be performed by a mobile terminal, wherein character input may be from a keypad, and presenting matched words may be displayed on a display.

Other embodiments include an apparatus comprising a processor; and a memory, the memory including executable instructions, that when provided to the processor, cause the apparatus to perform receiving input comprising one or more characters; determining if sensor data regarding a location is available; if sensor data regarding a location is available, determining a geographical location, and processing the sensor data to identify at least one object positioned proximate the determined geographical location; obtaining at least one location specific word based on the identified at least one object; and determining if the at least one location specific word would match the received one or more input characters into a word, and if so, presenting the at least one matched word as a potential completion. An apparatus may include a mobile terminal or a camera. Embodiments may further include executable instructions wherein processing the sensor data to identify at least one object positioned proximate the determined a geographical location may comprise transmitting to a wireless network information regarding the determined geographical location; receiving from the wireless network information regarding objects proximate to the determined geographical location; and utilizing the received information regarding objects proximate to the determined geographical location to identify the at least one object from the sensor data.

Embodiments may include transmitting to a wireless network information regarding the identified at least one object; and receiving from the wireless network the least one location specific word. Embodiments may also include an apparatus wherein the sensor data includes a camera image, and the determined geographical location includes the geographical location where the camera image was created. Embodiments may also include instructions for determining a geographical orientation for the camera image; and utilizing the determined geographical location and the determined geographical orientation to identify at least one object positioned proximate the determined geographical location.

An embodiment may also include a computer readable medium including executable instructions that cause a processor or other device to perform any of the systems, processes and methods described herein.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an exemplary mobile device that may utilize and be improved by embodiments of the present invention;

FIG. 2 illustrates a block diagram of an embodiment of the present invention;

FIGS. 3A and 3B illustrates a method according to an embodiment;

FIG. 4 illustrates a system according to some embodiments; and

FIG. 5 illustrates details of a method of some embodiments.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

Some embodiments of the present invention are directed towards finding words that are most relevant to the user based on inputs from location, near field communication (NFC), and/or camera sensors. These words may then be used in a word prediction algorithm so that a user is given relevant word completion choices. In some embodiments, a basic word list stored in a device is utilized, with a separate list of relevant words based on the sensed location information. The words relevant to the inputs from the sensors may be given higher weighting or importance. If new words are found, they may be downloaded from a server and added to the active wordlist.

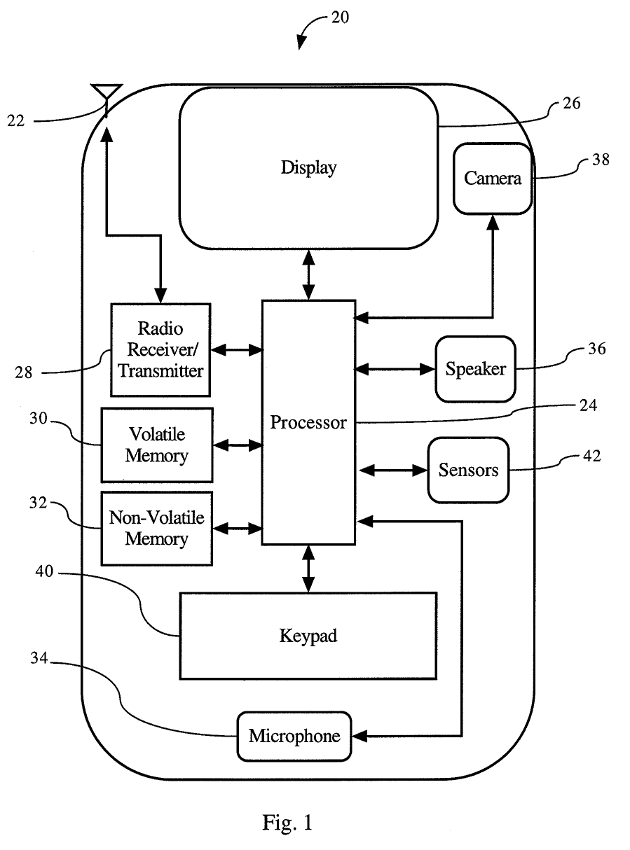

FIG. 1 illustrates a mobile terminal 20 that may benefit from embodiments of the present invention. Mobile terminal 20 may comprise a network-enabled wireless device, such as a digital camera, a cellular phone, a mobile device, a data terminal, a pager, a laptop computer or combinations thereof. Further, the mobile terminal 20 may comprise any combination of network-enabled wireless devices and non network-enabled devices. As a network-enabled device, the mobile terminal 20 may communicate using one or more antennas 22 over a radio link to a wireless network (not shown) and through gateways and web servers. Examples of wireless networks include third-generation (3G) cellular data communications networks, Global System for Mobile communications networks (GSM), WLAN networks, or other wireless communication networks. Mobile terminal 20 may also communicate with a web server using one or more ports (not shown) on that may allow a wired connection to the Internet, such as universal serial bus (USB) connection, and/or via a short-range wireless connection (not shown), such as a BLUETOOTH™ link or a wireless connection to WLAN access point. Thus, mobile terminal 20 may be able to communicate with a web server in multiple ways.

As shown in FIG. 1, the mobile terminal 20 may include a processor 24 and various types of memory, such as volatile memory 30 and non-volatile memory 32. The memory 30, 32 may store data and information and also instructions to be executed by the processor 24 to control the mobile terminal 20 and enable applications to be performed on or by it. The mobile terminal 20 may also include a radio transmitter/receiver 28 in communication with the processor 24 that enables wireless communications as previously described, and may also provide short-range radio communications, such as communications via a BLUETOOTH™ link or communications with radio frequency identification (RFID) tags. The radio transmitter/receiver 28 may also receive GPS transmissions and communicate with processor 24 to enable the processor to determine current location information for mobile terminal 20. Alternatively, separate GPS circuitry or systems may be included. Mobile terminal 20 may also take advantage of other positioning mechanisms, such as positioning methods based on communication signals between the mobile device and base stations (e.g., triangulation methods) and proximity based methods (e.g., communication with a BLUETOOTH proximity sensor).

The mobile terminal 20 may also include a display 26 to visually display images, text and other data. The mobile terminal 20 may also include one or more speakers 36 to provide sound output to a user, to play all types of audio including received telephone audio and stored audio and music. The mobile terminal 20 may also include various types of input devices or sensors, including a microphone 34, camera 38, keypad 40, and other sensors 42. These other devices or sensors allow a user and the environment to provide input to the mobile terminal 20. The camera 38 may allow still images or motion video to be recorded and stored in the memory 30, 32, transmitted using the radio transmitter/receiver 28, or processed by the processor 24. The microphone 34 may provide sound detection and processing, including allowing a user to perform voice communications, record audio, and control devices using voice commands and speech recognition.

A keypad 40 allows a user to enter data, may include a numeric keypad with standard digits (0-9) and related keys (#, *), as well as other hard and soft keys used for operating and entering data into mobile terminal 20. The keypad 40 may also include a QWERTY keyboard and keypad, or a touch screen interface.

Other sensors 42 may be included in mobile terminal 20, such as accelerometers, compasses, etc. that can provide environmental and context information to the mobile terminal 20. For example, accelerometers or a compass within mobile terminal 20 may provide information in concert with GPS or other location information to provide functionality for some embodiments, as will be described below. Other types of sensors include sensors for various RF signals (including RFID) sensors for infrared signals and data, vibration or impact sensors, etc.

In combination, one or more user inputs 34, 40, display 26, and processor 24 in concert with instructions stored in memory 30, 32, may form a graphical user interface (GUI), which allows a user to interact with the mobile terminal 20 and other devices available over a wireless network. An example feature is an ability for users to enter text using a keypad 40, with the text being displayed on the display 26 as it is entered. As the user is entering text, a feature may be implemented that provides word completion to the user, to increase the ease, speed and accuracy of entering text.

Embodiments of the present invention may provide candidate words for completion of partially entered words based on information provided by sensors. Such information may include location, orientation, views, weather (light, darkness, precipitation, temperature), images, information in images (such as structures, monuments, text, signs, barcodes (as read by a barcode scanner or a camera), ordinary objects, object shape, color, symbols, etc), tags including RFID (Radio Frequency Identification) tags, low level or short range radio or infrared signals, etc. Embodiments of the present invention may utilize and process this information to determine what candidate words to use or prioritize as candidate words for partial-word completion as a user enters text.

In some embodiments, relevant words are determined based on inputs from location sensors, near field communication (NFC) sensors, and/or camera sensors. These words are used in a word prediction algorithm so that the user is given word completion choices that are relevant to the inputs from the sensors based on partial word entry. A basic word list stored in a device such as a mobile terminal may be utilized; however, words relevant to the inputs from the sensors may be given a higher weighting or importance. If new words are found they may be downloaded from a server and added to the active wordlist.

As an example use case for an embodiment, a user on the streets in New York City points her mobile device with a camera at the Empire State building. An image of the building is processed, and a determination is made that the object in the image is the Empire State building. This processing may take place at a server in communication with the user's mobile device. Information may be sent to the mobile device regarding the Empire State building, including information such as the location, name, how far it is from the user, etc. The user wishes to send a text message to a friend, or perhaps make an inquiry to some on-line information provider. The user then starts entering text on the mobile device, for example requesting specific information about the building. According to an embodiment, location specific words are given higher importance while the user is typing. If the user types “Em”, the word completion algorithm may suggest “Empire State Building” as a valid completion. As another example, the user may wish to save the photo, or send the photo to a friend, and wants to label the photo. An embodiment will assist the user by providing “Empire State Building”, or other terms, to help in labeling the photos.

Another example use case for an embodiment is finding information about items and objects. A user may point a mobile device to an item in a shop, such as a pair of shoes on display in a store window. One or more sensors of the mobile device obtain information on what the user is pointing at. As one example, a service, such as “Point & Find” service provided by Nokia, Inc., determines general information about the object (shoes), or specific information (Dream Couple shoes) and pushes information to the mobile device. As another example, an RFID tag placed within or near the shoes provides information on the shoes. This can be detailed information, or a general identification number that can then be used to obtain further information from a general service. This information can be then provided to a display on the mobile device. If the user wants more information the user can make an inquiry using text input. The user could inquire from a general service available over a wireless network, or a local source such as a wireless node or BLUETOOTH node within the store. As the user enters text, item specific words are given higher weighting for completion. For example, if the user types “Dr”, the word completion algorithm would suggest “Dream Couple”.

As another example use case, an embodiment may help a user find information about restaurants. A user would point a camera device at one or more different restaurants, and receive information about the restaurants. In an embodiment, a service such as Point & Find service would recognize specific restaurants, or the concept of restaurants generally, and may push information to the user's camera device, such as hours, food, reviews, special offers, etc. If the user wants to find more information regarding a specific restaurant or maybe other restaurants in the area, as the user enters text into some inquiry application, location and/or item specific words are given higher weighting. As an example, if the user types “Pi”, the word completion algorithm may suggest “Pizzeria”, or “Nearby Pizzerias”. As a related example a user may send a text message to friends inquiring if they want to have pizza or if anyone has information about this particular restaurant. The word completions based on the determined information will help the user enter such text.

As a related example, in another embodiment the user would not need to point a camera of other device at possible restaurants, but if the restaurant or locations have near field communications (NFC) devices such as RFIDs or information RF sources such as BLUETOOTH, a sensor in the user's mobile terminal can pick up this information and automatically enable word completion based on the locations and object without any required action by the user.

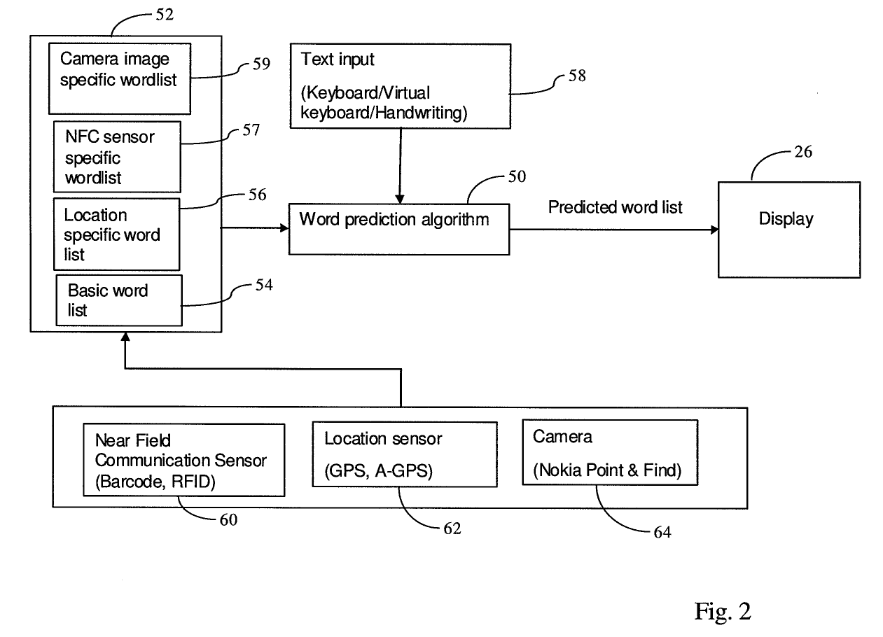

FIG. 2 illustrates features of an embodiment of the present invention. A word prediction algorithm 50 works to predict what is being entered by some type of text input 58. This text input may be from a keypad 40 as described with FIG. 1, or a keyboard, virtual keyboard, touch screen, or handwriting entry system. The word prediction algorithm 50 also has available to it a list or database of possible words 52. In this embodiment, the word prediction algorithm 50 attempts to find some or all words in the word list 52 that may match the text entered so far, and present a reasonable list of matching words on the display 26 so the user can select a matching word. The word list 52 may include different sub lists such as a basic word list 54, and also other location and item specific word lists 56, 57, and 58. These location and item specific word lists may be combined, or separated, and may be temporary, such as being reset based on a certain length of time, or be updated as a First In First Out (FIFO) queue where old or seldom matched words are dropped from the various lists as new words are added. Alternatively, the lists of words 54, 26, 57, and 58, may be permanent, and simply accumulate new word entries

Such location and item specific word lists may include a location specific word list 56, an NFC specific word list 57, and/or a camera image specific word list 59. These word lists may be obtained from a wordlist manager, as described below. The word list manager may receive input from various sensors in order to generate location and item specific words, or to prioritize possibly matching words. Such sensors include near field communication sensors 60, such as bar code or RFID tag readers. Such sensors for information include a camera 38, antenna 22, radio receiver/transmitter 28, microphone 34, and other sensors 42 (FIG. 1). The wordlist manager may also receive input and information from sensors relating to location 62, such as Global Positioning System (GPS) information, Assisted GPS (A-GPS) information, information based on trilateration, accelerometers, orientation detectors, etc. Other such types of information the wordlist manager may utilize is information from images 64, such as images obtained from a camera, or images sent to a device (such as email or text message attachments, or viewed images from a web page or otherwise). Such image information may be obtained by image processing occurring locally in a mobile device or personal computer, or at a remote server or processor. The wordlist manager may use information from such sources 60, 62 and 64, or other such information regarding location or content, to select and/or prioritize a predicted word list to display on a display 26 for a user.

The wordlist manager may obtain such “dynamic” wordlists from a server. In the server the wordlists may be indexed in multiple ways. One way is based on the location cell (which is a geographical region around a mobile device user's GPS location). The list may be an index of relevant static structures and/or landmarks (streets, buildings, etc) in that region. Further, such lists may also include common words used by people in that region. For items such as shoes on display, the item specific wordlist may be instantaneously updated from the sensor input (RFID, barcode, etc.) 60. In an embodiment, such word lists may be prioritized. For example, if a camera is pointed at an object to provide camera image data 64, and/or if there is active RFID/Barcode sensor data 60 associated with that object, then words specific to that object(s) may get priority. Words specific to the location 56 may be secondary in the priority list. Basic wordlists 54 which may be loaded from a dictionary built into the device (e.g., T9), may be given the least priority.

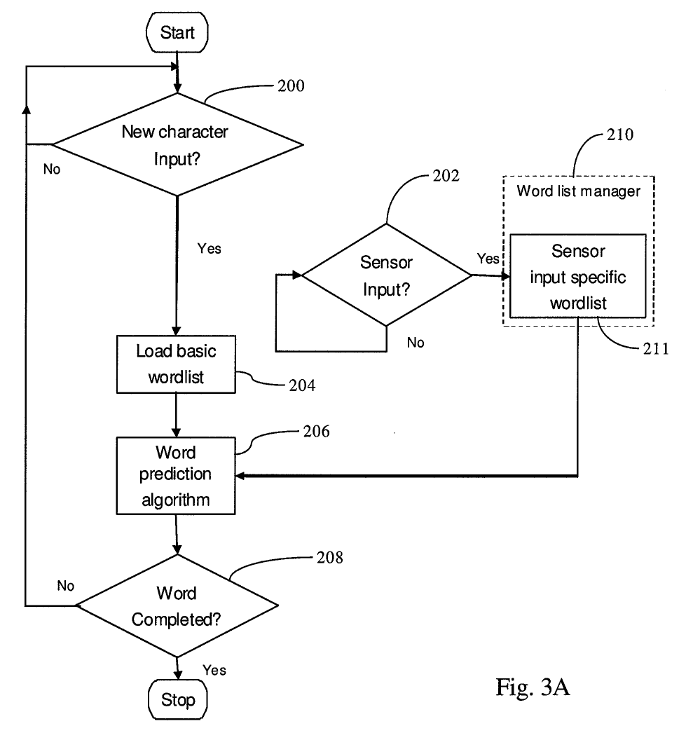

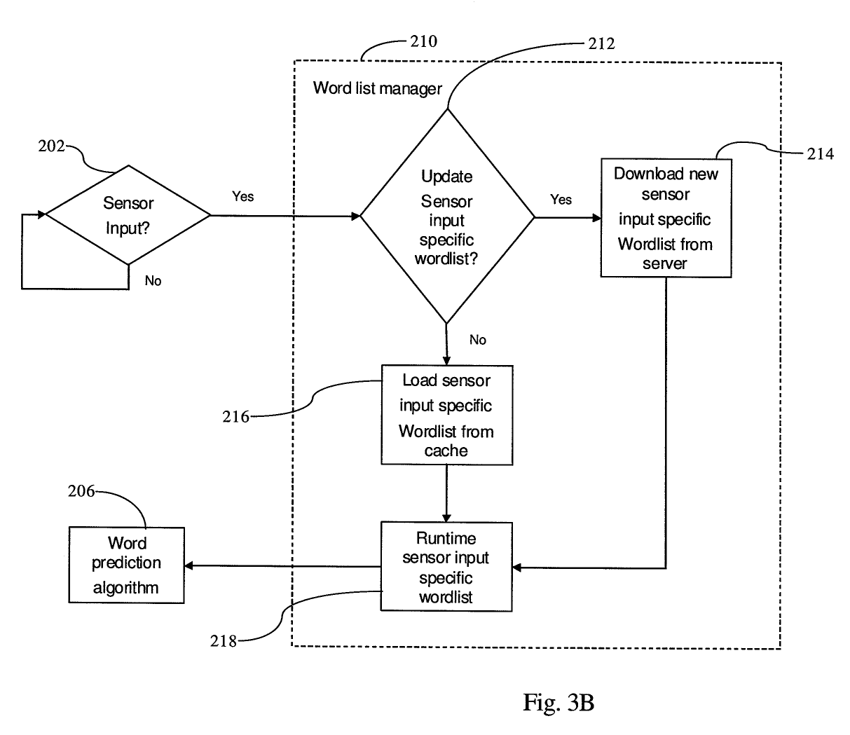

FIGS. 3A and 3B describe a method used by an embodiment of the present invention. As one or more characters are entered, step 200, a basic word list may be loaded if necessary, step 204, and a word prediction algorithm 206 may attempt to match the entered characters against the basic word list in a conventional manner. If sensor data or input is available, the word prediction algorithm 206 may utilize any available or provided sensor specific wordlists. 211. Checking for sensor data or input, step 202, may performed at any time characters are entered, step 200, or may run as a separate asynchronous process. This step of checking for sensor input 202 may be run in the background as part of the wordlist manager 210, whereupon when wordlist manager provides new words are available, they can be added to the location and item specific wordlists. More details on the functioning of the wordlist manager 210 will be provided below. This process for predicting words with updated word lists may loop or continue step 208, until a word has been completed. The method or process may be repeated for following words

FIG. 3B describes processing by a word list manager 210 according to one or more embodiments. At step 202, an embodiment determines whether sensor data is available. Sensors may signal when data is available, or sensors may be actively queried to determine of any sensor data is available, or any history or event lists regarding sensor data may be reviewed. For example, if a camera image was recently recorded (including possibly within a predetermined time limit), it may be considered sensor data for processing. Changes in sensor inputs may be detected based on changes in location of a device (as determined by GPS or A-GPS co-ordinates), changes of images displayed in a viewfinder, changes in input received from NFC sensor (RFID, Barcode). If it is determined that one or more input specific word lists should be updated, then new sensor input specific word lists may be obtained or downloaded from a server, step 214. If wordlists do not need to be updated from server at step 212, then sensor input specific wordlist may be loaded from a cache. The cache holds the words used previously in the same location with the same device. It may also hold the words from an NFC sensor (since these words were acquired directly from the objects in the vicinity of the device). The cache may also be used when there is no network connection to the server. The result of this process is a runtime sensor input specific wordlist 218, that may then be used by the word prediction algorithm 206 in conjunction with the basic word list loaded at step 204 (FIG. 3A), for selecting and prioritizing possible matching words. As previously described an embodiment may prioritize sensor input specific wordlists over basic wordlists.

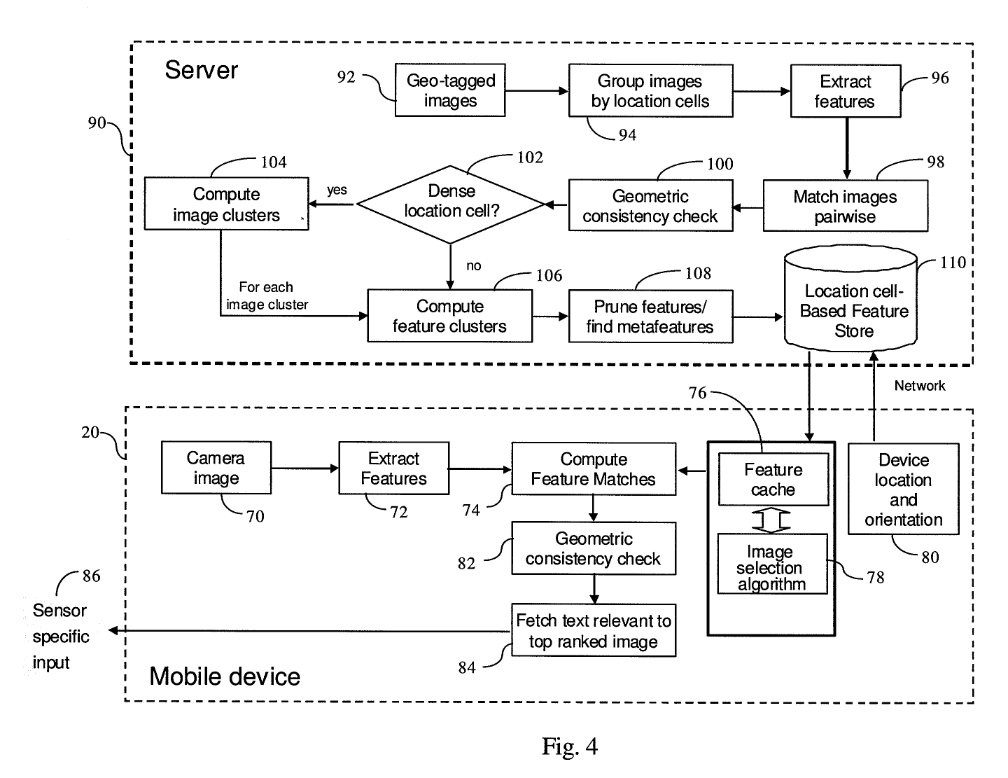

FIG. 4 provides details of embodiments that may utilize services available on a server 90. The server 90 may communicate with a device such as a mobile terminal 20 over a wireless network. For an embodiment, the server 90 may create and maintain information about locations, landmarks, and objects, and may provide such information to a device. This information may include location or object specific words that may be used by embodiments to provide improved word completion for text input.

One or more geo-tagged images 92 may be provided. These images may portray landmarks, and/or objects that are positioned at specific geographic locations, such as building, landmarks, and structures (both natural and manmade) etc. These images may then be geographically grouped by some type of grouping structure, such as objects and locations that are within a specific cell for a cellular network. Other types of groupings are possible. The images are then processed to identify and extract features, step 96. Such features for extraction are typically invariant to size, rotation and illumination of the image and discriminative. An example of such a feature set, as well as a process for extraction is given by David G. Lowe, Distinctive Image Features from Scale-Invariant Keypoints, International Journal of Computer Vision, 60, 2 (2004), pp. 91-110. The images from same location cell may then be matched up pairwise to form an image graph, step 98. The image graph may consist of different views of same objects taken from different angles and distances. A geometric consistency check is then performed, step 100, to make sure that different objects appearing in the images taken from different perspectives are consistent in their length along different dimensions. Meta features may then be extracted from images, step 106, however if the location cell is dense, step 102, the image graph may be cut into image clusters 104, and meta features are extracted from the clustered images, step 106. These metafeatures are pruned to remove the outliers, step 108. Complete details regarding an implementation of such a system are presented in slides by Gabriel Takacs, Vijay Chandrasekhar, Natasha Gelfand, Yingen Xiong, Wei-Chao Chen, Thanos Bismpigiannis, Radek Grzeszczuk, Kari Pulli, and Bernd Girod, Outdoor Augmented Reality on Mobile Phone using Loxel-Based Visual Feature Organization, presented at the ACM International Conference on Multimedia Information Retrieval (MIR'08), Vancouver, Canada, October 2008. The resulting processed image and location information is then stored 110 in order to be utilized by embodiments.

Although the processing has been shown in terms of a server 90, one or all of the steps and processes may be performed on other devices, such as a mobile device or computer. Further, although the information is described as being grouped or indexed by location cells, other types of indexing are possible, for example by geographic location such as world coordinates etc., or grouped by provincial, local, or national borders or demarcations.

As illustrated in FIG. 4, a process as performed by a mobile device 20 may process a camera image 70 to identify locations or objects in the image. For this exemplary embodiment, this image process may include feature extraction 72, to determine features that may be matched against information about locations and objects in the vicinity of the camera used to obtain the image. The geographic location of the mobile device 20 may be determined by sensors as previously described, along with geographic orientation information which may be obtained through one or more sensors as will be described below. This geographic location and orientation information 80 may be queried against the database 110 to determine what locations and objects to try to identify within the camera image 40. All or some data in the database 110 may be stored in the mobile device 20, possibly depending on memory size. A set of features 76 may be returned based on the location and orientation information 80. Depending on the features 76, different image selection algorithms 78 may be utilized to attempt to match the features. Complete details regarding such a process is an implementation of the system are described the slides for Outdoor Augmented Reality on Mobile Phone using Loxel-Based Visual Feature Organization (2008), as previously cited.

After one or multiple matches are determined, an embodiment may perform a geometric consistency check 82, in a similar manner is performed in step 100 on the server side. Then for matched locations or objects in the images, text regarding those location or objects may be obtained 84, for example from the server 90. If multiple matched locations and objects are identified, the process may include a ranking of likely matches, and/or possible matching location and object words that are appropriately ranked or prioritized.

Although many of these steps and processes are described as being performed on a mobile device 20, one or all of these steps may be performed by a server 90, or by some other processing networked device. For example, a mobile terminal 20 may simply transmit the camera image to a server that performs the object of location identification, which sends back information or a list of appropriate location specific words. This list of words may be prioritized, either as a default, or based on the specific image. A server providing this service can obtain location and orientation information from a mobile device with appropriate sensors, or from querying a mobile terminal user for such information.

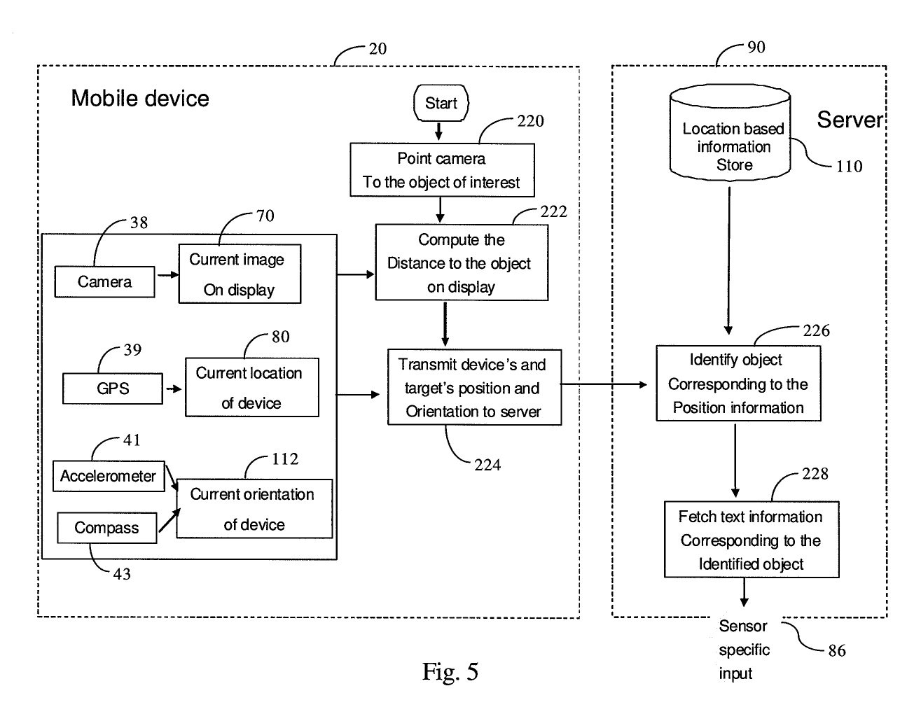

FIG. 5 provides information regarding a process as performed by an embodiment. As previously described, a user may point a device with a camera or image sensing device 38 at an object or location of interest, step 220. Information from sensors may then be obtained, such as location information 80 from a GPS sensor 39, as previously described. Information regarding an orientation of the device 112 may be obtained and/or calculated using an accelerometer 41 and/or other devices such as an electronic compass 43.

At step 222 an embodiment may analyze the camera image 70 and compute a distance to an object in the image. This distance computation may be performed by methods known in the art, such as focus information determined by the camera. Other methods of determining distance are also possible, for example using a camera's field of view together with the camera's determined location to determine possible visible objects. Another example is to use a distance sensor pointed in the direction of camera. By knowing the present position of the device, the orientation (direction) of the device, and a distance to an object viewed in the camera image 70, an embodiment can determine the position of the object or location based on vector coordinates or standard surveying techniques. This processing may be performed by the mobile device 20, or the information sent to a server 90 to determine the general or exact location of the object. At step 224, information about the mobile device's position, and orientation, and distance to the target object is transmitted to a server. By using this location information for searching a location based information store 110, information about prospective locations or objects may be obtained. At step 226, this information is used to identify objects and locations in the image 70, using techniques previously described Now that the locations and objects have been identified, text information may be requested regarding the locations and objects. This text information may include specific words to insert into a location specific word list 56 FIG. 2, or may be general text about the location and object, and a separate step may be used to select words from the general text to add to the location specific word list 56.

Although an embodiment is described for FIG. 5 that utilizes camera image analysis, another embodiment may utilize only position information to determine sensor specific data 86. Referring back to the example of a person pointing a mobile device at the Empire State Building, an embodiment may depend only on the mobile device location and orientation information, to determine what locations or landmarks would be in a line of site of where the mobile device is pointing. If a person is at a known location and pointing the mobile device in a certain direction, an embodiment can analyze the direction vector to determine if any landmarks are located along that vector. If for example the Empire State Building is located along that vector, and is a reasonable distance away, the embodiment may identify the Empire State Building as a potential identified object or landmark without performing image analysis.

One or more aspects of the invention may be embodied in computer-usable data and computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A method comprising:
receiving input comprising one or more characters;
determining if sensor data regarding a location is available;
if sensor data regarding a location is available, determining a geographical location, and processing the sensor data to identify at least one object positioned proximate the determined geographical location;
obtaining at least one location specific word based on the identified at least one object; and
determining if the at least one location specific word would match the received one or more input characters into a word, and if so, presenting the at least one matched word as a potential completion.

2. The method of claim 1 wherein processing the sensor data to identify at least one object positioned proximate the determined a geographical location includes:
transmitting to a wireless network information regarding the determined geographical location;
receiving from the wireless network information regarding objects proximate to the determined geographical location; and
utilizing the received information regarding objects proximate to the determined geographical location to identify the at least one object from the sensor data.

3. The method of claim 1 wherein obtaining at least one location specific word based on the identified at least one object includes:
transmitting to a wireless network information regarding the identified at least one object; and
receiving from the wireless network the least one location specific word.

4. The method of claim 1, wherein the sensor data includes a camera image, and the determined geographical location includes the geographical location where the camera image was created.

5. The method of claim 4 wherein identifying an object in the camera image includes:
determining a geographical orientation for the camera image; and
utilizing the determined geographical location and the determined geographical orientation to identify at least one object positioned proximate the determined geographical location.

6. The method of claim 5 further including:
calculating a distance value to an object determined to be in the camera image; and
utilizing the distance value along with the determined geographical location and the determined geographical orientation to identify at least one object positioned proximate the determined geographical location.

7. The method of claim 1 wherein sensor data includes data received from a radio frequency identification (RFID) tag.

8. The method of claim 1 wherein presenting the at least one matched word as a potential completion includes presenting a list of possibly matching words, wherein the at least one matched word is prioritized in the presentation list.

9. An apparatus comprising:
a processor; and
a memory, the memory including executable instructions, that when provided to the processor, cause the apparatus to perform:
receiving input comprising one or more characters;
determining if sensor data regarding a location is available;
if sensor data regarding a location is available, determining a geographical location, and processing the sensor data to identify at least one object positioned proximate the determined geographical location;
obtaining at least one location specific word based on the identified at least one object; and
determining if the at least one location specific word would match the received one or more input characters into a word, and if so, presenting the at least one matched word as a potential completion.

10. The apparatus of claim 9 wherein the memory further includes executable instructions wherein processing the sensor data to identify at least one object positioned proximate the determined a geographical location comprises:
transmitting to a wireless network information regarding the determined geographical location;
receiving from the wireless network information regarding objects proximate to the determined geographical location; and
utilizing the received information regarding objects proximate to the determined geographical location to identify the at least one object from the sensor data.

11. The apparatus of claim 9 wherein the memory further includes executable instructions wherein obtaining at least one location specific word based on the identified at least one object comprises:
transmitting to a wireless network information regarding the identified at least one object; and
receiving from the wireless network the least one location specific word.

12. The apparatus of claim 9, wherein the sensor data includes a camera image, and the determined geographical location includes the geographical location where the camera image was created.

13. The apparatus of claim 12 wherein the memory further includes executable instructions regarding identifying an object in the camera image, comprising:
determining a geographical orientation for the camera image; and
utilizing the determined geographical location and the determined geographical orientation to identify at least one object positioned proximate the determined geographical location.

14. The apparatus of claim 13 wherein the memory further includes executable instructions for performing:
calculating a distance value to an object determined to be in the camera image; and
utilizing the distance value along with the determined geographical location and the determined geographical orientation to identify at least one object positioned proximate the determined geographical location.

15. The apparatus of claim 9 wherein the apparatus includes a mobile terminal.

16. The apparatus of claim 9 wherein presenting the at least one matched word as a potential completion includes displaying on a display a list of possibly matching words, wherein the at least one matched word is prioritized in the display list.

17. A computer readable medium including executable instructions to perform:
receiving input comprising one or more characters;
determining if sensor data regarding a location is available;
if sensor data regarding a location is available, determining a geographical location, and processing the sensor data to identify at least one object positioned proximate the determined geographical location;
obtaining at least one location specific word based on the identified at least one object; and
determining if the at least one location specific word would match the received one or more input characters into a word, and if so, presenting the at least one matched word as a potential completion.

18. The computer readable medium of claim 17 further including executable instructions wherein processing the sensor data to identify at least one object positioned proximate the determined a geographical location includes:
transmitting to a wireless network information regarding the determined geographical location;
receiving from the wireless network information regarding objects proximate to the determined geographical location; and
utilizing the received information regarding objects proximate to the determined geographical location to identify the at least one object from the sensor data.

19. The computer readable medium of claim 17 further including executable instructions wherein obtaining at least one location specific word based on the identified at least one object includes:
transmitting to a wireless network information regarding the identified at least one object; and
receiving from the wireless network the least one location specific word.

20. The computer readable medium of claim 17 further including executable instructions wherein the sensor data includes a camera image, and the determined geographical location includes the geographical location where the camera image was created, and including executable instructions to perform:
determining a geographical orientation for the camera image; and
utilizing the determined geographical location and the determined geographical orientation to identify at least one object positioned proximate the determined geographical location.
